(19) United States
(12) Patent Application Publication
(10) Pub. No.: US 2014/0279652 A1
(43) Pub. Date: Sep. 18, 2014

(54) POINT OF SALE SYSTEMS AND METHODS

(71) Applicant: WIKIBREW SOFTWARE STUDIOS, LLC, Ann Arbor, MI (US)

(72) Inventors: Chull Victor KIM, Ann Arbor, MI (US); Gregory A. BREWER, Brighton, MI (US)

(73) Assignee: WIKIBREW SOFTWARE STUDIOS, LLC, Ann Arbor, MI (US)

(21) Appl. No.: 13/826,134

(22) Filed: Mar. 14, 2013

(51) Int. Cl. G06Q 10/08

(52) U.S. Cl. CPC G06Q 10/0833
USPC 705/333; 705/330

(57) ABSTRACT

An indication is received from a delivery client device that an order is accepted for delivery. Order delivery information is provided to the delivery client device. A notification is sent to a customer device that the order has been provided for delivery. An indication is received from the delivery client device of a present location on a delivery route. An order status update message is sent to the customer device based on the location.

### BACKGROUND

Merchants such as restaurants generally desire to process orders in an efficient and timely manner. However, managing customer expectations with respect to an amount of time needed by the merchant to process and provide an order can be difficult, especially when order processing times can vary according to time of day, current order volumes, etc. Further, managing orders such as orders for pickup and/or delivery of food items can present a number of challenges. For example, ensuring an efficient flow of orders once they are received can be difficult. Further, it can be difficult to coordinate multiple deliveries at various locations.

### BRIEF DESCRIPTION OF THE DRAWING FIGURES

FIG. 1 illustrates an exemplary system for processing and delivering orders.

FIG. 2 illustrates an exemplary process for processing orders.

FIG. 3 illustrates an exemplary process for processing orders for delivery as a continuation of the process of FIG. 2.

FIG. 4 illustrates an exemplary process for providing estimated order wait times.

FIG. 5 illustrates a first exemplary process for adjusting a delivery agent's route and/or order queue during a delivery trip.

FIG. 6 illustrates a second exemplary process for adjusting a delivery agent's route and/or order queue during a delivery trip.

FIG. 7 is a block diagram of an exemplary graphical user interface that might be displayed by a POS terminal.

### DETAILED DESCRIPTION

### System Overview

FIG. 1 illustrates an exemplary system 100 for processing orders. A server 105, which may utilize a data store 110, communicates, generally via a network 115, with one or more point of sale terminals 120. The server 105 and/or the point of sale terminal 120 generally also communicate via the network 115 with one or more customer clients 125 and/or a delivery client 130.

The server 105 is a computing device that includes a processor and a memory, the memory storing instructions executable by the processor for carrying out all or portions of processes including as described herein. Further, although a single server 105 and a single data store 110 are shown in FIG. 1, it is to be understood that multiple instances of these components could be used and/or combined to provide operations in the system 100 ascribed to them herein.

The server 105 generally includes various software modules that comprise one or more sets of computer-executable instructions, such as an order processing module, a web server module, etc. For example, a web server, as is known, may include instructions for generating and/or providing web pages to the terminal 120, clients 125, etc. Additionally or alternatively, the server 105 may include instructions for receiving data from, and providing data to, various applications, such as mobile applications on a terminal 120, client 125, and/or delivery client 130. Further additionally or alternatively, the server 105 may include instructions to provide notifications and the like to clients 125 and/or 130, e.g., via emails, short message service (SMS) messages, etc.

Processes that may be included in an order processing module are described further herein below, and may include mechanisms for receiving information about customer orders, e.g., from the terminal 120 and/or client 125, processing such orders, storing information about orders in the data store 110, etc. The web server, order processing module, and/or other instructions included in the server 105 may also include instructions for sending and receiving data with one or more delivery clients 130. The server 105 may be in a location with one or more POS terminals 120, but generally is located in a data center or the like in a location remote from other elements of the system 100.

As shown in FIG. 1, the data store 110 may be included in a separate physical device from the server 105, but the data store 110 could also be memory or storage included in the server 105. The data store 110 may include information for generating one or more web pages accessible by terminal 120 and/or clients 125. The data store 110 may further include information to be provided to, or stored from, a delivery client 130, as well as historical information related to orders processed by the server 105 and/or received from terminals 120.

Network 115 is a packet network and is generally an internet protocol (IP) network. As such, the network 115 generally uses one or more known protocols for transporting data, such as user datagram protocol (UDP), transport control protocol (TCP), hypertext transfer protocol (HTTP), etc. Further, network 115 may include one or more of a variety of networks such as a wide area network (WAN), e.g., the Internet, a local area network (LAN), a cellular network, etc. As is known, packet network 115 may be used to transport a variety of digital data. Network 115 may include wireless and/or wired elements. Generally, although not necessarily, communications, notifications, exchanges of data, etc., described herein between elements of the system 100, including the server 105, the POS terminal 120, and clients 125, 130, take place via the network 115.

The point of sale (POS) terminal 120 is generally a computing device having a processor and a memory, the memory storing instructions executable by the processor for carrying out all or portions of processes including as described herein. In one exemplary implementation, the POS terminal 120 is a general-purpose computing device running the Windows 7 operating system provided by Microsoft Corporation of Redmond, Wash. Further in this exemplary implementation, the POS terminal 120 includes a web browser, e.g., Microsoft Internet Explorer, the Chrome browser from Google Inc. of Mountain View, Calif., etc. In this implementation, the server 105 generally provides a graphical user interface, e.g., via a web page, for receiving orders, receiving and displaying orders, etc., in the POS terminal 120.

Although only one POS terminal 120 is shown in FIG. 1, it is to be understood that the system 100 may include more than one, even tens, hundreds, or thousands, of POS terminals 120. Each POS terminal 120 is generally included in a merchant location where customer orders are received, e.g., a restaurant. Further, some order-receiving locations may include multiple POS terminals 120.

The POS terminal 120 may include or be in communication with a data store 121. The data store 121 may be included in a separate physical device from the POS terminal 120, but the data store 121 could also be memory or storage included in the POS terminal 120. In general, instructions stored and/or executed by the POS terminal 120 may be stored in the data store 121. Further, data disclosed herein as being stored in and/or retrieved from or by the POS terminal 120 may be stored in the data store 121.

Clients 125, such as the clients 125a and 125b shown in FIG. 1, may be any computing device capable of communicating with the server 105, and a processor and a memory, the memory storing instructions executable by the processor for carrying out all or portions of processes including as described herein. For example, the client 125 may be a portable computing device such as a smart phone or the like running the iOS operating system provided by Apple, Inc. of Cupertino, Calif., the Android operating system provided by Google Inc., etc. Further, the client 125 could be a laptop computer, desktop computer, etc., e.g., using Microsoft's Windows operating system, and operating system provided by Apple, Inc. such as OS X, the Linux operating system, etc.

Generally using a web browser, mobile application, or the like, a client 125 may access the server 105. For example, the client 125 may be used to browse a menu or list of items that may be ordered, to place orders, and/or to monitor progress of order delivery. The client 125 may further receive notifications from the server 105, e.g., using an email application, an SMS application, etc.

Delivery client 130, such as the clients 130a and 130b shown in FIG. 1, may be any computing device capable of communicating with the server 105, and a processor and a memory, the memory storing instructions executable by the processor for carrying out all or portions of processes including as described herein. For example, the client 130 may be a portable computing device such as a smart phone or the like running the iOS or Android operating systems. The client 130 may include a specialized order delivery mobile application, a standard web browser or the like, and/or other mechanisms for communications with the server 105. Further, the client 130 generally includes a global positioning system (GPS) application. A specialized order delivery mobile application may use the GPS application as described further herein below.

FIG. 2 illustrates an exemplary process 200 for processing orders. As described further below, in some instances, notably where an order is to be delivered to a remote location, the process 200 may be combined with a process 300 discussed below with respect to FIG. 3.

The process 200 begins in a block 205, in which an order is received at the server 105. For example, the order may include a selection of items from a restaurant menu for pickup or delivery. The order could alternatively or additionally include a selection of other items; for convenience and ease of explanation, the present disclosure generally describes the system 100 with respect to implementations where a merchant processing orders is a restaurant, and where restaurant orders are being processed. Information included in an order received in the block 205 may also include a customer name, contact information such as an email address and/or cellular telephone number, payment information, such as whether the customer will pay by cash or payment card, a type of payment card, a payment card number, etc. Further, in general, a sale is completed, e.g., a payment card transaction may be processed, when an order is placed. For example, a POS terminal 120 may be used to process a cash or payment card transaction.

Accordingly, the server 105 may provide a user interface, e.g., a webpage, a menu via a specialized application such as a mobile application, etc. via which a user of a client 125 may select and order menu items. Further, the user interface provided by the server 105 generally allows a user to specify whether an order is for pickup or delivery. However, implementations are possible in which a client 125 may only place orders for one of pickup or delivery, or in which other options, such as placing an order to be consumed at a restaurant location, are provided.

Moreover, the user interface provided by the server 105 may allow or require a user to specify a geographic location. For example, a restaurant may have multiple locations; the user interface displayed on a client 125 accordingly could include a form or the like for a user to specify a particular restaurant location at which an order is to be placed. Alternatively or additionally, a user could be provided a form or some other mechanism for providing an address or geographic location to which an order is to be delivered.

Next, in a block 210, the server 105 provides the order to a POS terminal 120. For example, the order could be provided to the POS terminal 120 in the form of a webpage and/or data for a specialized POS application. In cases where a restaurant has multiple locations, the server 105 could select an appropriate POS terminal 120 to receive an order according to a user selection of a specific location, according to a user-provided address, etc. Although not illustrated in FIG. 2, it is also possible that, according to an address or location provided from a client 125, the server 105 could determine that the order cannot be processed, e.g., the specified address or location is outside a specified delivery area, whereupon the process 200 could be terminated.

A block 215, in which order data is displayed on a POS terminal 120, is executed following the block 210. In some cases, the order may be displayed on multiple POS terminals 120 in a location, e.g., at a register location and at a kitchen location in a restaurant. Further, in an exemplary implementation, as mentioned above, order data is provided for display in a web page displayed in a web browser included in the POS terminal 120. Additionally or alternatively, the order could be provided to a printer, e.g., in a restaurant kitchen, whereby a paper copy of the order could be provided.

Thus, in this exemplary implementation, the terminal 120 is used to display data from, and receive inputs for, the server 105; because such operations are performed via a standard web browser, with further order processing operations being performed by the server 105 such as described herein, a specialized order processing application on the POS terminal 120 is not necessary. However, the POS terminal 120 could include further instructions, e.g., embodied in a specialized POS or order processing application, in which case the POS terminal 120 could perform at least some of the operations described herein to the server 105.

Next, in a block 220, the server 105 updates the order status to indicate that the order is being processed. For example, the server 105 may store in a memory, in the data store 110, etc., a flag or other variable to indicate an order status. Further, the server 105 may provide a status indicator reflecting a value of such variable for interfaces of clients 125, 130 and/or the POS terminal 120.

Also in the block 220, and at other points in processes 200, 300 described herein, other information may be updated, e.g., on one or more merchant webpages provided by the server 105 relating to orders and/or order processing. For example, FIG. 4 below describes a process for providing estimated order wait times, which may be displayed along with order status information, or on some other webpage or interface populated with data from the server 105, e.g., an interface of a client 125. Further, for delivery orders, the server 105 could include instructions for a map to be provided for viewing, e.g., in a webpage or the like, by the client 125, the map indicating a location of an order. For example, a delivery client 130 could update the server 105 periodically, e.g., every minute, every two minutes, etc., with its location, and the server 105 could update a map with a location of the delivery client 130 for clients 125 associated with customers expecting orders from the delivery agent with the delivery client 130. In addition, a webpage provided by the server 105, a mobile application on a client 125, etc., could include a mechanism for sending and receiving messages. For example, the webpage could include an HTML (hypertext markup language) form, an e-mail form or prompt, a mechanism for sending an SMS message, or the like, for a user to provide delivery instructions, comments about an order, etc. A message from a client 125 could be sent to POS terminal 120 and/or a delivery client 130.

Moreover, in a block 225 that follows the block 220, the server 105 may provide a notification of the order status to the customer that placed the order. For example, in placing the order the customer may have provided contact information as discussed with respect to block 205, such as an email address, cellular telephone number, or the like, to which such notification may be sent. The server 105 may thus in real-time or near real-time send to the customer an email, SMS message, etc. concerning the order status, e.g., with respect to the block 225, indicating that the order is “in process.”

Next, in a block 230, the server 105 determines whether the order is completed for provision to a customer, e.g., ready for pickup or delivery. For example, the server 105 may provide a mechanism in a user interface, e.g., a webpage, displayed by the POS terminal 120, for a merchant's, e.g., a restaurant's, staff, to indicate that an order is complete. If the order is not complete, the server 105 continues to wait for input indicating that the order is complete. Once such indication is received, the process 200 proceeds to a block 235.

In the block 235, the server 105 updates the order status to indicate that the order is ready. For example, upon receiving input as described with respect to block 230, the server 105 may change the value of a flag or variable such as discussed concerning the block 220 to indicate that the order is “complete.”

Next, in a block 240, the server 105 determines whether the order is for pickup or delivery. As mentioned above, the order could be categorized in other ways, e.g., as being for in-store consumption, in which case the order could be processed in a manner similar to that described herein concerning pickup orders. In any case, if the order is for pickup, the process 200 proceeds to a block 245. If the order is not for pickup, in the exemplary implementation being described, this means that the order is for delivery. In this case, the process 200 continues as the process 300, described below with respect to FIG. 3.

In the block 245, the server 105 provides a “ready for pickup” status notification to a customer, e.g., in a manner such as described above with respect to the block 225.

Next, in a block 250, an order is completed, e.g., ordered items may be provided to a customer picking them up.

Next, in a block 255, the server 105 records the order and marks it as complete. For example, the POS terminal 120 may provide data concerning the order, e.g., a time of pickup, a mode of payment, a time of the order, and any other data related to the order, to the server 105. Accordingly, the server 105 generally records the order as complete, stores such data in the data store 110, and terminates operations with respect to the order received as described above with respect to step 205.

Following the block 255, the process 200 ends.

FIG. 3 illustrates an exemplary process 300 for processing orders for delivery. As stated above, the process 300 is a continuation of the process 200 following the block 240.

The process 300 begins, i.e., continues the process 200, in a block 305, in which a completed order is placed in a delivery queue of orders to be delivered, and is assigned to a delivery agent. One or more delivery queues may be maintained, e.g., for delivery agent, for a merchant location, for a POS terminal 120, etc. For example, a restaurant may have one or more delivery personnel on foot, on bicycles, or in vehicles. The server 105 may assign specific orders to particular delivery agents according to various mechanisms. The POS terminal 120 could include a mechanism for staff at a merchant location to assign a completed order to a specific delivery agent or orders could be assigned according to a round-robin process whereby orders are assigned to a next available delivery agent. Alternatively or additionally, the server 105 could assign an order to a delivery agent according to the geographic location, e.g., a delivery agent could be assigned to a particular merchant location and/or to a particular geographic area, etc. Further, the server 105 may include instructions for considering other factors, such as a number of orders presently assigned to a particular delivery agent, a location or locations of such orders, traffic conditions in a geographic area being serviced by the delivery agent, etc.

Next, in a block 310, the server 105 sends a notification to the delivery agent selected in the block 305 that the order is assigned to the delivery agent and ready for delivery. For example, a notification could be sent via SMS message, or as a notification to a mobile application included on a delivery client 130.

Next, in a block 315, the server 105 registers that an order has been picked up for delivery. For example, when a delivery agent picks the order up for delivery, the delivery agent could provide input to the server 105 via a webpage or mobile application user interface in the delivery client 130 that the order has been picked up. For example, the delivery agent could, e.g., according to instructions in a mobile application, use delivery client 130 to scan visual identifier such as a Quick Response Code (QR Code), bar code, or the like on an order ticket to signify that an order had been picked up for delivery. Likewise, such input could be provided via the POS terminal 120. The server 105 may then update appropriately an order status flag or variable, e.g., to a value of “out for delivery” or the like.

A delivery agent may, and often will, be assigned multiple orders for delivery on a single trip. Accordingly, block 315 may be executed simultaneously or nearly simultaneously for multiple orders to be delivered on a single trip by a particular delivery agent.

Next, in a block 320, the server 105 sends a customer notification, e.g., via one or more mechanisms discussed above, e.g., an e-mail, an SMS message, and/or posting on a webpage provided by the server 105, etc., indicating that the order is out for delivery. Alternatively or additionally, a delivery client 130 could send an e-mail, SMS message, or the like, e.g., triggered by acceptance of a scan of a bar code or QR code as described above, or based on input to a mobile application on a client 130 by a delivery agent to send a message concerning order status.

Next, in a block 325, the server 105 generally updates appropriately an order status flag or variable, such as discussed above, e.g., to a value of “out for delivery” or the like.

Next, in a block 330, the server 105 updates the delivery client 130 with data needed to deliver the order. For example, an order number or the like and an associated location, e.g., an address, telephone number, GPS coordinates, etc., may be provided to the delivery client 130. As mentioned above, a mobile delivery application may include or use a GPS navigation module. For example, upon receipt of delivery data, the client 130 could provide a delivery agent with information to locate a delivery location, such as an address, a street-view photograph, turn-by-turn directions, etc. Further, in cases where the delivery agent has picked up multiple orders for delivery to multiple locations, the client 130 could calculate a desirable route for delivering the orders, and an order of delivering the orders, e.g., based on delivery locations, traffic conditions, and possibly other factors.

Some or all of the route calculation as described above being performed by the client 130 could be performed by the server 105. Further, it is possible that a delivery agent's route and/or orders assigned to the delivery agent may be changed mid-route. For example, FIG. 5 illustrates an exemplary process for a delivery agent to adjust a route and orders to be delivered. FIG. 6 illustrates a further exemplary process by which a delivery agent's route and/or orders to be delivered may be adjusted during a delivery agent's delivery trip.

Next, in a block 335, a customer notification is provided that an order delivery is forthcoming. For example, an application on delivery client 130 could be configured to send a text message, automatically place a telephone call, send instructions to server 105 to place a telephone call or send a message, etc., upon receiving input to do so. Such input could be provided by a delivery agent to the application on the delivery client 130, e.g., by tapping an icon associated with a customer order, etc. Further, the input could be provided by the delivery client 130 application, in conjunction with a GPS application, determining that a delivery agent was a predetermined amount of time, e.g., five minutes, away from delivering an order, whereupon the customer notification could be provided. As discussed above, the clients 125 and 130 may include mechanisms for sending messages to and from each other. As an example, a client 125 could send a message to the delivery client 130 upon receiving a notification that an order delivery is imminent. For example, a customer may wish to provide last-minute delivery instructions, e.g. “Sleeping baby, please knock lightly.” Further, the delivery agent 130 could use the delivery client 130 to respond e.g., “At the door; won't knock.”

Next, in a block 340, upon delivery of an order, the delivery client 130 receives input indicating that the delivery is complete. For example, a delivery agent could scan a barcode, QR code, or the like on a delivery ticket, or could provide some other input, e.g., manually selecting a button or other input mechanism, indicating that the order has been delivered. Further a sales transaction may be completed earlier, e.g., as described above with respect to block 205 of process 200, the delivery client 130 may operate as a point of sale terminal, e.g., may perform operations as described above concerning the POS terminal 120 in block 250 of the process 200.

Next, in a block 345, the delivery client 130 provides delivery data input as described above concerning the block 335 to the server 105. The delivery data may be included in a log and/or stored in the data store 110. Further, an order status flag or variable such as discussed above may be set to “complete” or the like.

Next, in a block 350, the server 105 may provide updates concerning the completion of the order delivery, e.g., displays on POS terminal 120, client 125, etc., may be updated to indicate that the order has been delivered and a sale is complete. Alternatively or additionally, notifications such as described above could be sent to a user, a delivery agent, etc., confirming that the delivery is complete. Such mechanisms serve to confirm the delivery, and provide a customer with opportunity to contact a merchant if a delivery is not in fact complete, and order is incorrect, etc.

Next, in a block 355, the server 105 removes the order from its delivery queue, and may log a record of the delivery, e.g., in the data store 110.

Following the block 355, the combined processes 200, 300 end.

FIG. 4 illustrates an exemplary process 400 for providing estimated order wait times.

The process 400 begins in a step 405, in which the server 105 receives input indicative of order wait times at a merchant location, e.g., in a particular restaurant. For example, an interface of a point of sale terminal 120 may include a mechanism for receiving estimates of order wait times such as may be provided by staff observing time taken to process orders. Optionally but importantly, prior to providing input estimating order wait times, a staff member providing such input may be required to authenticate his or her identity, e.g., by providing a username, passcode, personal identification number, and/or biometric data, etc. to the point of sale terminal 120. The point of sale terminal 120, e.g., in the data store 121, could maintain a record of staff persons authorized to provide wait-time inputs. Requiring such authentication can help improve the accuracy of estimated wait times.

An example of a mechanism for providing wait-time estimates includes a slider control or the like, that may be manipulated with a pointing device, touchscreen, or the like, to indicate wait times. For example, FIG. 7 is a block diagram of an exemplary graphical user interface (GUI) 700 that might be displayed by a POS terminal 120. The GUI 700 includes a slider control 705, that in turn includes a sliding pointer 710 beneath and pointing to a location on a slider bar 715. The GUI 700 further includes a wait-time display 720. A user can move the pointer 710 along the slider bar 715, whereupon a wait time indicated by a location of the pointer 710 is displayed in the wait-time display 720. Such control 705 is generally calibrated to a timescale, e.g., 90 minutes, where moving the pointer 710 all the way to a left-hand side indicates no wait time, placing the slider in the middle of the scale indicates a 45 minute wait time, and moving the slider all the way to a right-hand side indicates a 90 minute wait.

Input indicative of order wait times could also be provided via other mechanisms. For example, the POS terminal 120 and/or the server 105 could include instructions for computing an average time between an order being placed, and an order sale transaction being completed, whether as part of a pickup order or a delivery order. Such average could be computed for orders placed within a predetermined period of time, e.g., the last 30 minutes, the last 60 minutes, etc. Further, the time period for computing the average could be changed based on order volume. For example, the average could be computed simply for the last 10 orders, or could be computed for orders received in the last 30 minutes if more than 10 orders have been received in the last 30 minutes, otherwise computed for orders received in the last 60 minutes, etc. Moreover, for delivery orders, an order wait time indicated by a slider control 705 or some other mechanism may be adjusted to account for time needed to deliver the order in addition to the estimated time for the order to be ready for pickup or delivery. For example, the order wait time indicated by slider control 705, etc., may be added to a predetermined time, a time provided by some other input, etc., representing an estimated time for delivery, in order to provide an overall estimate of the time it will take for a customer to receive an order.

Another possible mechanism for receiving input indicative of order wait times could be to receive user input. For example, a webpage or other user interface provided by the server 105 could allow input via a client 125 indicating an amount of time it took for an order to be processed at a particular merchant location. Such user estimates of order wait times could be averaged as described above, and could be displayed in lieu of or alongside estimated wait times based on the other input mechanisms discussed above.

Following the block 405, in a block 410, the server 105 identifies a user providing input described with respect to the block 405. The user providing the input may be prompted to provide an identification. For example, such a prompt may be desirable if multiple users have access to an input mechanism, e.g., multiple users may have access to a POS terminal 120. In some implementations, if a user cannot be identified, or if the user is not identified as a user authorized to estimate order wait times, the process 400 may end after the block 410. Alternatively or additionally, the process 400 may use an identity of a user providing an estimate of order wait times to weight the user's estimate when computing an estimated order wait time for display in interface provided by the server 105. For example, if a user is identified as a user of a client 125, that user's estimate may be given less weight than an estimate by a user of a POS terminal 120 in a merchant location.

Next, in a block 415, an order wait time indicator on a local user device is adjusted. For example, if a user adjusts a slider control on a POS terminal 120, the slider control may be adjusted in an interface displayed on the POS terminal 120 to reflect the estimated wait time indicated by the user. In some instances, the block 415 may be omitted. For example, input provided from a client 125 or input that will be averaged or otherwise used in a computation with additional input may not be reflected in an indicator provided on the client 125. Rather, the client 125 will receive an updated estimated wait time, e.g., as discussed with respect to a block 420.

The block 420 follows the block 415. After input is received in block 405, and user identification has been performed as described above concerning block 410, an estimated order wait time for a merchant location may be computed. In some cases, the estimated wait time is simply determined according to an input control mechanism, e.g., according to a position of a slider control in an interface provided on a POS terminal 120. However, an estimated wait time could also be computed, e.g., averaged from a variety of inputs, as described above. In any event, the server 105 may provide for display on remote devices, such as webpages viewable via clients 125, an indication of an estimated order wait time. For example, the server 105 could cause a representation of a slider control or the like to be displayed and/or could display a number of minutes or the like that are estimated for an order wait time.

Next, in a block 425, the estimated wait time and/or estimated delivery time is saved by the server 105, e.g., in the data store 110. Accordingly, various metrics may be computed, such as a comparison of estimated times to actual times, to gauge accuracy of various staff members and/or store locations in estimating the times.

Following the block 425, the process 400 ends.

FIG. 5 illustrates a first exemplary process 500 for adjusting a delivery agent's route and/or order queue during a delivery trip. The process begins in a block 505, in which a mobile application or the like on a delivery client 130 displays information about orders being delivered by other delivery agents, i.e., by one or more delivery agents not associated with the particular delivery client 130.

Next, in a block 510, the delivery client 130 communicates with a second delivery client 130. For example, upon reviewing other delivery agents' orders as described with respect to the block 505, a first delivery agent, i.e., user of the delivery client 130, may note that one or more of the other agents orders' could be more efficiently delivered in conjunction with orders being delivered by the first delivery agent. Similarly, the first delivery agent could note that a second delivery agent could more efficiently deliver one or more orders for which the first delivery agent is presently responsible. Accordingly, the first delivery agent could communicate with one or more second delivery agents to suggest that orders be transferred and/or exchanged. Such communication could be made by a telephone call, text message, or the like, but could also be made, for example, by the first delivery agent providing an input to a mobile application on the client 130. Such mobile application could include instructions for providing a notification to a second delivery agent proposing an exchange and/or transfer of orders. Further, a mobile application on a second client 130 being used by the second delivery agent could provide a mechanism for the second delivery agent to return the communication, e.g., decline the proposal, agreed to meet at a specified location, etc.

Next, in a block 515, a first delivery agent and at least one second delivery agent exchange and/or transfer one or more orders.

Next, in a block 520, the first and second delivery agents, e.g., according to instructions in a mobile application on respective clients 130, update the server 105 concerning the exchange and/or transfer of orders. For example, the delivery agents could use respective delivery clients 132 scan a barcode, QR code, or the like on tickets of orders being exchanged, whereupon, the mobile application may update the server 105. Other mechanisms for updating the server 105 are possible. For example, a delivery agent could provide input to a mobile application by selecting an order from a list and indicating that the order had been received or transferred to a second delivery agent, etc., whereupon such selection could be transmitted to the server 105.

Next, in a block 525, the first and second delivery agents update their respective order delivery routes, e.g., according to instructions in respective delivery clients 130. The delivery agents then proceed to execute the updated routes.

Following the block 525, the process 500 ends.

FIG. 6 illustrates a second exemplary process 600 for adjusting a delivery agent's route and/or order queue during a delivery trip. For example, the server 105 may perform operations to compare a first delivery agent's route and orders with a route and orders of at least one second delivery agent as a basis for a route adjustment. In an exemplary implementation, the process 600 may be performed as an adjunct to, or sub-process of, the delivery process 300 discussed above. For example, the process 600 could be performed in conjunction with, or between, blocks 330 and 335 of the process 300, e.g., between the provision of delivery data to a client 130, and an indication that delivery is complete.

The process 600 begins in a block 605, in which the server 105 receives order queues and delivery routes for at least two delivery agents who are on delivery trips, i.e., have accepted one or more orders for delivery as described above with respect to the process 300.

Next, in a block 610, the server 105 compares the respective delivery routes received in block 605, and determines adjustments to be made to respective delivery agents' routes and/or order queues. For example, the server 105 may determine whether a first delivery agent can more efficiently deliver an order in an order queue of a second delivery agent, whether orders will be more efficiently delivered if a first agent and a second agent meet during their respective delivery trips and swap orders, etc. [CAN WE PROVIDE MORE DETAIL ABOUT AN ALGORITHM FOR DETERMINING WHEN TO ADJUST ROUTES?]

Next, in a block 615, the server 105 determines if any adjustments resulted from the block 610. If not, the process 600 ends. Otherwise, the process 600 proceeds to a block 620.

In the block 620, the server 105 sends notifications to one or more delivery clients 130 associated with respective delivery agents whose routes and/or order queues are being adjusted. Such notification may be sent by mechanisms discussed above, such as an SMS message to a delivery client 130.

Next, in a block 625, the server 105 determines whether it has received an acknowledgment from each of the one or more delivery agents to whom it notifications were sent in block 620. In some implementations, a delivery agent may be provided with an interface in the delivery client 130 to decline a route adjustment proposed by the server 105. For example, a delivery agent may wish to decline a route adjustment for an order that the delivery agent knows will be delivered relatively soon. Generally, it is desirable for the server 105 to receive an acknowledgment of a route adjustment from a delivery client 130 to ensure that a delivery agent will follow a new route, exchange one or more orders with a second delivery agent, etc. In some cases, if an acknowledgment is not received from a delivery client 130 within a predetermined period of time, such as two minutes, the server 105 will determine that the route adjustment has been declined. In any case, if one or more agents decline a route adjustment, the process 600 may end. Otherwise, the process 600 may proceed to a block 630.

In the block 630, the server 105 records the one or more confirmations of respective route adjustments received from delivery clients 130, e.g., in a memory, in the data store 110, etc.

Next, in a block 635, the server 105 records a new route or routes and/or orders assigned to respective delivery agents, e.g., in a memory, in the data store 110, etc.

Following the block 635, the process 600 ends.

Computing devices such as those disclosed herein may employ any of a number of computer operating systems known to those skilled in the art, including, but by no means limited to, known versions and/or varieties of the Microsoft Windows® operating system, (e.g., Windows 8 Pro) the Unix operating system (e.g., the Solaris® operating system distributed by Sun Microsystems of Menlo Park, Calif.), the AIX UNIX operating system distributed by International Business Machines of Armonk, N.Y., the Linux operating system, etc. Computing devices may include any one of a number of known computing devices, including, without limitation, a point of sale terminal, a computer workstation, a desktop, notebook, laptop, or handheld computer, or some other known computing device.

Computing devices generally each include instructions executable by one or more computing devices such as those listed above. Computer-executable instructions may be compiled or interpreted from computer programs created using a variety of known programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases or data stores described herein may include various kinds of mechanisms for storing, accessing, and retrieving various kinds of data, including a hierarchical database, a set of files in a file system, an application database in a proprietary format, a relational database management system (RDBMS) such as MS SQL Server, etc. Each such database or data store is generally included within a computing device employing a computer operating system such as one of those mentioned above, and is accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites explicitly to the contrary.

What is claimed is:

1. A method, comprising:
receiving an indication from a delivery client device that an order is accepted for delivery;
providing order delivery information to the delivery client device;
sending a notification to a customer device that the order has been provided for delivery;
receiving from the delivery client device an indication of a present location on a delivery route;
sending an order status update message to the customer device based on the location.

2. The method of claim 1, further comprising sending an order status update message from the client device to the customer device.

3. The method of claim 1, further comprising receiving an indication from the delivery client device that the order is delivered.

4. The method of claim 1, further comprising receiving a communication from a second delivery client device with respect to the order.

5. The method of claim 1, further comprising receiving a communication from the delivery client accepting a second order.

6. The method of claim 1, wherein the indication that the order is accepted for delivery is initiated by scanning a visual identifier with the delivery client.

7. The method of claim 1, further comprising providing the order status update message to a remote interface that is an interface in a mobile application or a web page, whereby an updated order status is displayed in the remote interface.

8. A method, comprising:
receiving input indicating an estimated wait time for an order;
identifying a user associated with the input;
determining whether the user is deemed reliable for estimating wait times; and
if the user is deemed reliable, updating a graphical user interface that is provided via a network to provide a display of the estimated wait time.

9. The method of claim 8, wherein the input is provided by adjusting a slider control provided in a local graphical user interface.

10. The method of claim 8, further comprising storing the estimated wait time, and performing at least one of (a) comparing the estimated wait time to an actual wait time to determine a level of accuracy of the estimated wait time and (b) storing the estimated wait time, and comparing the estimated wait time to an actual wait time to determine a level of reliability of the user.

11. A computing device comprising a processor and a memory, the memory storing instructions executable by the processor, the instructions including instructions for:
receiving an indication from a delivery client device that an order is accepted for delivery;
providing order delivery information to the delivery client device;
sending a notification to a customer device that the order has been provided for delivery;
receiving from the delivery client device an indication of a present location on a delivery route;
sending an order status update message to the customer device based on the location.

12. The device of claim 11, wherein an order status update message is sent from the client device to the customer device.

13. The device of claim 11, the instructions further including instructions for receiving an indication from the delivery client device that the order is delivered.

14. The device of claim 11, the instructions further including instructions for receiving a communication from a second delivery client device with respect to the order.

15. The device of claim 11, the instructions further including instructions for receiving a communication from the delivery client accepting a second order

16. The device of claim 11, wherein the indication that the order is accepted for delivery is initiated by scanning a visual identifier with the delivery client.

17. The device of claim 11, the instructions further including instructions for providing the order status update message to a remote interface that is an interface in a mobile application or a web page, whereby an updated order status is displayed in the remote interface.

18. A computing device comprising a processor and a memory, the memory storing instructions executable by the processor, the instructions including instructions for:
receiving input indicating an estimated wait time for an order;
identifying a user associated with the input;
determining whether the user is deemed reliable for estimating wait times; and
if the user is deemed reliable, updating a graphical user interface that is provided via a network to provide a display of the estimated wait time

19. The device of claim 18, wherein the input is provided by adjusting a slider control provided in a local graphical user interface.

20. The device of claim 18, the instructions further including instructions for storing the estimated wait time, and performing at least one of (a) comparing the estimated wait time to an actual wait time to determine a level of accuracy of the estimated wait time and (b) storing the estimated wait time, and comparing the estimated wait time to an actual wait time to determine a level of reliability of the user.
